(19) United States
(12) Patent Application Publication
(10) Pub. No.: US 2005/0098255 A1
(43) Pub. Date: May 12, 2005

(54) Insulation product having nonwoven facing and process for making same

(76) Inventors: Michael J. Lembo, Souderton, PA (US); Murray S. Toas, Norristown, PA (US)

Correspondence Address: DUANE MORRIS, LLP;IP DEPARTMENT, ONE LIBERTY PLACE, PHILADELPHIA, PA, 19103-7396, US

(21) Appl. No.: 10/704,317

(22) Filed: Nov. 6, 2003

(51) Int. Cl. B32B 31/00

(52) U.S. Cl. 156/167; 156/177; 156/181

(57) ABSTRACT

Insulation products having nonwoven facings and processes for making such products are provided. In a preferred process of making an insulation product, a mat is formed containing randomly oriented inorganic fibers bonded by an adhesive. The mat includes a pair of side portions and first and second major surfaces thereon. A nonwoven layer is formed in situ onto the mat. The nonwoven layer comprises a resinous material which is melt bonded to at least the first major surface of the mat. The preferred insulation products are porous to water vapor and permit air to be evacuated from the mat when the insulation product is compressed, such as during packaging. The preferred insulation products include a nonwoven layer having a thickness of less than about 1 mil and an ASTM E-84 flame spread test of 25 or less in the absence of fire retardants.

### FIELD OF INVENTION

The present invention relates to inorganic fiber insulation products having one or more facings thereon, and more particularly, to inorganic fiber insulation mats or batts having a nonwoven facing adhered to at least one major surface thereof.

### BACKGROUND OF THE INVENTION

Batt insulation is commonly manufactured by fiberizing mineral fibers from a molten mineral bath by forcing them through a spinner rotating at a high number of revolutions per minute. The fine fibers are then contacted by a pressurized hot gas to draw the fibers to a useable diameter and length. The fibers are typically sprayed with a phenolic resin binder. The fibers are then collected and distributed on a conveyor to form a mat. The resin is then cured in a curing oven. The mat is then sliced into lengthwise strips having desired widths and chopped into individual batts. In some cases, a facing material, such as Kraft paper coated with a bituminous material or other vapor retarder, is added to the mat prior to the cutting step.

One of the known problems associated with installing glass fiber insulation materials is that they generate glass particle dust, which can be a cause of irritation to the skin of workers, and also can be inhaled. One way to reduce glass dust is to encapsulate insulation batts with a facing that reduces dust, but which is porous, and vapor permeable. WO94/29540, assigned to Owens Corning Fiberglas Corporation, teaches a polymeric facing which is adhered to one or both major surfaces of the batt with a fastening means, such as a small amount of adhesive material. The adhesive material is of a sufficiently small amount so as to enable the insulation batt not to exceed a flame spread rating of 25 using the ASTM E-84 flame spread test. The adhesive should be applied in sufficient quantity to bond the facing to the mineral fiber batt and enable the batt to be picked up and handled by the facing. The facings described in this reference are suggested to be a polypropylene or polyethylene material, which is adhered, stuck or heat sealed to the major surfaces of the batt.

Knapp et al., U.S. Pat. No. 5,848,509 commonly assigned with the instant application, teaches encapsulated glass fiber insulation within a nonwoven covering material. The nonwoven covering is disposed over the top surface of a mineral fiber core and extends adjacent the side surfaces. The covering is preferably formed from a web of nonwoven material, such as polyester, polypropylene, polyethylene or rayon, and is preferably applied to the top and sides of the glass fiber mat with a hot melt or suitable adhesive.

In order to provide insulation mats with encapsulated nonwoven coverings or films, a manufacturer needs multiple sizes of encapsulation materials for different product sizes. This can contribute greatly to the cost of the product since the inventory of different sized nonwoven fabrics must be stored and transported whenever needed. Additionally, quantities of adhesive must also be stored for adhering these coverings to batt insulation. Many adhesives and glues have a limited shelf life. Additionally, spraying these adhesives on batt surfaces requires constant cleanup and maintenance of manufacturing equipment and the work area.

Accordingly, there remains a need for an encapsulated or faced insulation material which can be made less expensively, but which still reduces dust and permits air evacuation when the insulation product is compressed for packaging.

### SUMMARY OF THE INVENTION

The present invention provides a method of making an insulation product in which a mat is formed containing randomly oriented inorganic fibers bonded by an adhesive. The mat includes a pair of side portions and first and second major surfaces thereon. The method next includes forming a nonwoven layer in situ onto said mat, said nonwoven layer comprising a resinous material which is melt bonded to at least the first major surface of the mat.

Fiber glass insulation products are often covered with polymer films or nonwoven materials by adhering a polymeric facing to one or more exposed sides of a batt. The present invention uses techniques for applying a continuous nonwoven layer in situ on at least a first major surface of an insulation mat or batt. This is very cost efficient since it generally eliminates the need for multiple sizes of nonwovens or films for different product sizes, allows the use of less expensive raw material (a polymer in solid form rather than a nonwoven fabric), and reduces the steps involved in manufacturing a nonwoven covered insulation product. Direct formation and application of a nonwoven fabric or film directly on a fiber glass insulation mat or batt also eliminates the need for a separate adhesive to adhere the fabric or film to the batt or mat surfaces. The direct formation of a fabric or film to a fiber glass mat or batt also results in an improved appearance of the fabric or film to the fiber glass insulation material.

In more detailed embodiments to the present invention, one or more series of polymer melters or extruders are connected to nonwoven producing dies or applicators positioned, for example, on the top, sides, and optionally, under the bottom of a lane or lanes of fiber glass insulation production line. Meltblown or spun-bond applicators can create and apply fine polymer fibers to a glass substrate. After the polymer is melted, extruded and conveyed to the meltblown applicator, for example, it can contact and bond to the fiber glass mat or batt in a nonwoven pattern. After the applied polymer fiber is applied to each other and to the fiber glass, and cooled to room temperature, the fiber glass insulation is covered with a nonwoven material. In the preferred embodiments of this invention, the nonwoven material is substantially porous to water vapor, and air, and provides a substantially nonirritating surface to human skin.

In a more detailed method of the present invention, a plurality of rotary inorganic fibers are spun from the molten bath. The rotary inorganic fibers are then assembled into a mat in which they are bonded by an adhesive. The mat includes a pair of side portions and first and second major surfaces thereon. Finally a nonwoven layer is formed in situ onto the first major surface of the mat. The nonwoven layer comprises a resinous material that is melt bonded to a plurality of said inorganic fibers of the first major surface. The first major surface is thereby substantially covered by the nonwoven layer.

In further more detailed embodiments of this invention, a nonwoven layer is formed by extruding a resinous material through a die having multiple apertures disposed therethrough to produce individual streams of molten polymer. These streams are blown with a high gaseous pressure to form a plurality of individual resinous fibers bonded to each other and to the rotary inorganic fibers by a melt bond.

### BRIEF DESCRIPTION OF THE DRAWINGS

The accompanying drawings illustrate preferred embodiments of the invention, as well as other information pertinent to the disclosure, in which:

FIG. 1 is a side elevation view of an insulation product of this invention;

FIG. 2 is a side elevation view of an insulation product alternative of this invention;

FIG. 3 is a side elevation view of still a further insulation product embodiment of this invention;

FIG. 3a is a side elevation view of still a further insulation product embodiment of this invention;

FIG. 4 is a schematic side elevation view of a process for producing the insulation product of FIG. 2; and

FIG. 5 is a front perspective view of a performing station for producing a nonwoven layer in situ onto an insulation mat or batt of this invention.

### DETAILED DESCRIPTION OF THE INVENTION

This invention provides methods for making insulation products and the insulation products themselves. As used herein, the term “in situ” means “in place”.

The nonwoven layers of this invention can be, for example, spun-bonded or meltblown nonwoven materials. In preferred embodiments of this invention, the nonwoven layer is a highly porous membrane, which enables quick air escape from the batt under conditions of rapid compression, such as during packaging. In one embodiment, the vapor retarder facing material layer and/or meltblown or spun-bonded nonwoven materials described below may also be less than or equal to one mil in thickness, preferably less than about 0.6 mil in thickness, and most preferably less that 0.4 mil in thickness, so that the final insulation batt readily meets the ASTM E-84 test for flame spread. The mass of these layers in this embodiment must be sufficiently low to obtain a flame spread rating of about 25 or less in the absence of fire retardants. For the purposes of this disclosure, the term “the absence of fire retardants” means that the material either actually contains no fire retardants, or contains fire retardants in such an insubstantial amount that the facing, in the adhered condition, would still obtain the flame spread rating of 25 or less if the fire retardant were left out of the product. In addition, the nonwoven layers of this invention desirably is slippery to enable the batt to be pushed or slid into place on top of existing attic insulation, for example. Preferably, the coefficient of kinetic friction of the surface of the nonwoven layer is less than 1.0, when the nonwoven layer surface is pulled or dragged across the surface of an unfaced glass fiber batt having a density of about 7-12 kg/meter³ (0.4 to about 0.8 pounds per cubic foot).

With reference to the Figures, and more particularly to FIGS. 1-3a thereof, there are shown four insulation products 100, 101, 102 and 103. Insulation products 100, 101, 102 and 103 include an insulation blanket or mat 10 formed from organic fibers such as polymeric fibers or inorganic fibers such as rotary glass fibers, textile glass fibers, stonewool (also known as rockwool) or a combination thereof. Mineral fibers, such as glass, are preferred. The thickness of the insulation blanket or mat 10 is generally proportional to the insulated effectiveness or “R-value” of the insulation. A vapor retarder facing layer 17, which may be a polymeric firm or typically formed from cellulosic Kraft paper coated with a bituminous material, thus providing a vapor retarder, is provided on one major surface 12 of the insulation blanket or mat 10 (except in the embodiment shown in FIG. 3a). The facing layer 17 and bituminous layer 16 together form bitumen-coated Kraft paper 31. In batt insulation 100, a pair of side tabs 18 and 19 are provided which can be unfolded and fastened to wooden or metal studs, for example. Various known configurations for side tabs or flaps 18 and 19 are known. The facing layer 17 can be vapor impermeable or permeable, depending on its makeup, degree of perforation, and intended use.

The insulation blanket or mat 10 is typically formed from glass fibers, often bound together with a resinous phenolic material. The insulation is typically compressed after manufacture and packaged, so as to minimize the volume of the product during storage and shipping and to make handling and installation of the insulation product easier. After the packaging is removed, the batt insulation products 100, 101, 102 or 103 tend to quickly “fluff up” to their prescribed label thickness for insulation.

Insulation intended for thermally insulating buildings typically has a low glass fiber density, such as from about 0.4 to 1.5 pounds per cubic foot (6.4× kg/m³ to 24× kg/m³), and often employs a Kraft paper facing coated on one side with a bituminous material. The coating is preferably applied in a sufficient amount so as to provide an effective barrier or retarder for water vapor, for example, so as to reduce the water vapor permeability of the preferred Kraft paper to no more than about one perm when tested by ASTM E96 Method A test procedure. In other forms, where a vapor retarder or barrier is not desired, the insulation blanket or mat 10 can have no facing on its second major surface 12. Optionally, the facing layer 17 can be secured to the bottom of major surface 12 of the insulation blanket or mat 10 by an adhesive, such as a hot-melt adhesive.

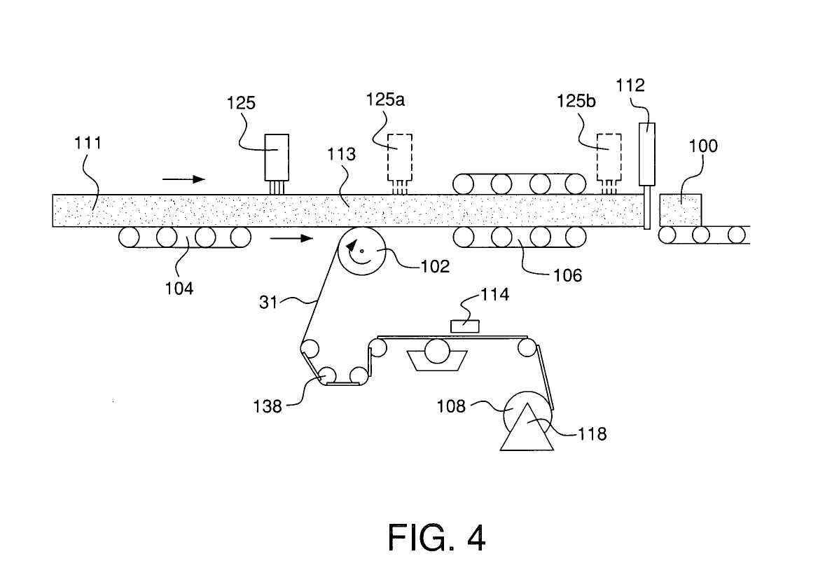

While in an un-encapsulated insulation product, exposed surfaces can make installation troublesome, and often release unbound fibers and dust into the working environment, the present invention employs a nonwoven layer 13 that protects at least the first major surface 11 of the insulation blanket or mat 10. Alternatively, the nonwoven layer can coat one or both side surfaces 14 and 15, and even part or all of the second major surface 12, to dramatically reduce the release of unbound fibers and dust. In further embodiments, the nonwoven layer 13 can be applied to the cut end surfaces, after the chopper 112 step (FIG. 4).

In batt insulation product 100, the nonwoven layer 13 additionally is directed beneath the product on the second major surface 12 for about 1-4 inches to partially encapsulate same prior to contacting the bitumen-coated Kraft paper 31. In batt insulation embodiment 101, this overlap in the lower portion of the major surface 12 is eliminated in favor of a full contact between the second major surface 12 and the bitumen layer 16 of the bitumen-coated Kraft paper 31. In batt insulation embodiment 102, the nonwoven layer 13 covers the first major surface 11, side surfaces 14 and 15, and overlaps a portion of the facing layer 17. In embodiment 101, the nonwoven layer 13 would be applied after the bitumen-coated Kraft paper 31 has been applied to the blanket or mat 10. Alternatively, the batt insulation can be completely encapsulated, or encapsulated on four of its six sides (excluding the cut ends), such as with batt insulation product 103 shown in FIG. 3a, with or without another facing layer 17 being applied.

The nonwoven layer 13 of this invention is preferably formed from a film or web of nonwoven material. The nonwoven materials of this invention are preferably formed in situ onto the surface of the insulation blanket or mat 10, preferably while the batt insulation products 100, 101, 102 or 103 themselves are being manufactured. Nonwoven materials are sheets of randomly oriented natural or synthetic fibers, such as polyolefins, polyamide (i.e., nylon) polyester or rayon, or glass sometimes secured together by a binder, typically based on a polymeric material, such as an acrylic resin, a vinyl-acrylic resin, or the like. In the preferred embodiments of this invention, organic thermoplastic fibers are joined together by a melt bond created by the coupling, mounting or fusing of the fibers to each other and to the inorganic fibers of the insulation blanket or mat 10. In an exemplary embodiment, the nonwoven is a thermally bonded thermoplastic. The nonwoven material may be, for example, meltblown or spun-bonded polyester or polyolefin, such as polyethylene or polypropylene, or polyamide. The nonwoven layer 13 is secured to at least the first major surface 11 at the same time it is formed on this surface, preferably by the same process that formed the fibers in the first instance. In such a case, a separate adhesive such as a hot melt adhesive is not required. This can be a factor in enabling the mat or batts of the present invention to achieve a “nonflammable” rating, or ASTM E-84 flame spread rating of 25 or less (See WO94/29540, p. 3). The nonwoven layer 13 can be applied to the first major surface 11, second major surface 12, side surfaces 14 or 15, the cut ends, or any combination of these surfaces.

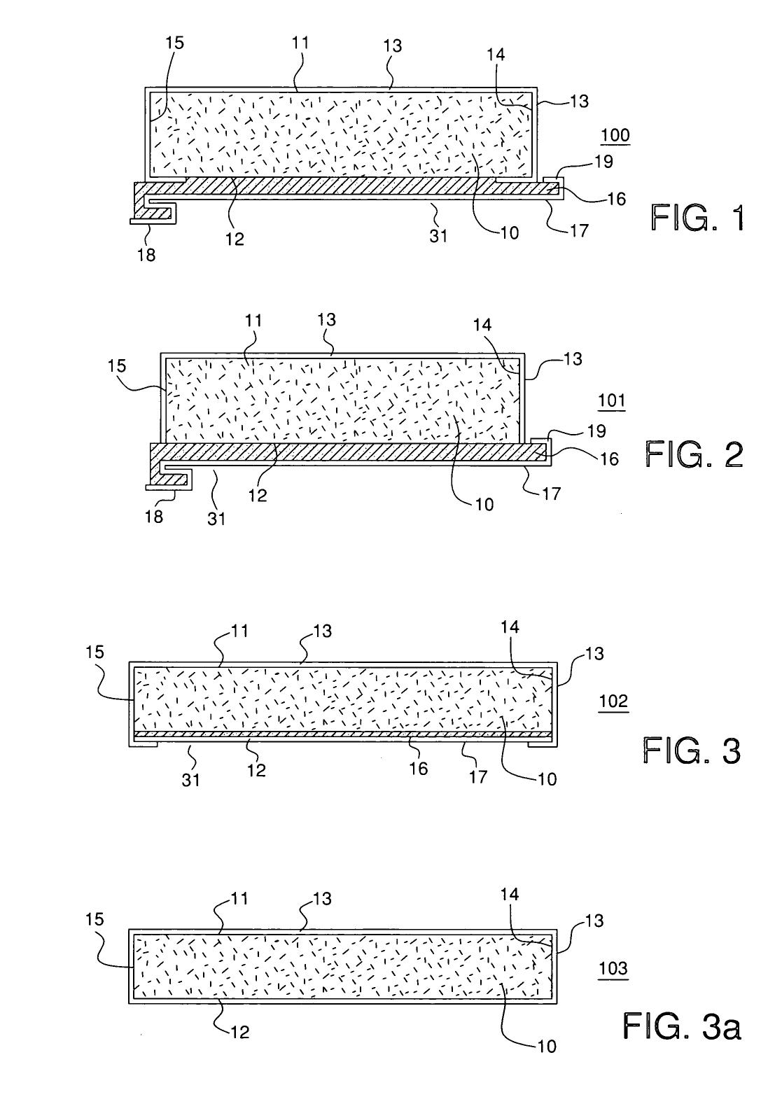

A process for producing the batt insulation 100 of FIG. 1 is shown schematically in FIG. 4. A continuous glass fiber blanket or mat 111 formed in a conventional manner is presented by a feed conveyer 104 to a heated roll 102, to which is simultaneously supplied a continuous web of bitumen-coated Kraft paper web 31, fed between the heated roll 102 and the glass fiber mat 111. The web of Kraft paper fed via roller 102 of FIG. 4 after being bitumen-coated is supplied from a roll 108 on payout stand 118, through an accumulator 138 for tensioning the Kraft paper web 31. In addition, the outside surface of the web can be marked at a marking station 114 with identifying information such as the R-value of the glass fiber mat and the production lot code before the Kraft paper web 31 is applied to the bottom of the glass fiber mat 111. Preferably, the edges of the Kraft paper web 31 are folded over to form the side tabs 18, 19 (FIG. 1 or 2) just prior to the web contacting the heated roll 102. The Kraft paper web 31 is oriented so that the bitumen-coated side of the Kraft paper web 31 faces the bottom of the glass fiber mat 111. The temperature is preferably selected to provide enough heat to soften the bituminous coating such that the bitumen-coated Kraft paper web 31 adheres to the underside of the glass fiber mat 111. The faced glass fiber mat 113 is transported away from the heated roll 102 by a tractor section 106, and delivered to a chopper 112, which periodically chops the faced glass fiber mat 113 to form insulation batts 100. The insulation batts 100 so formed are then transported to packaging equipment (not shown).

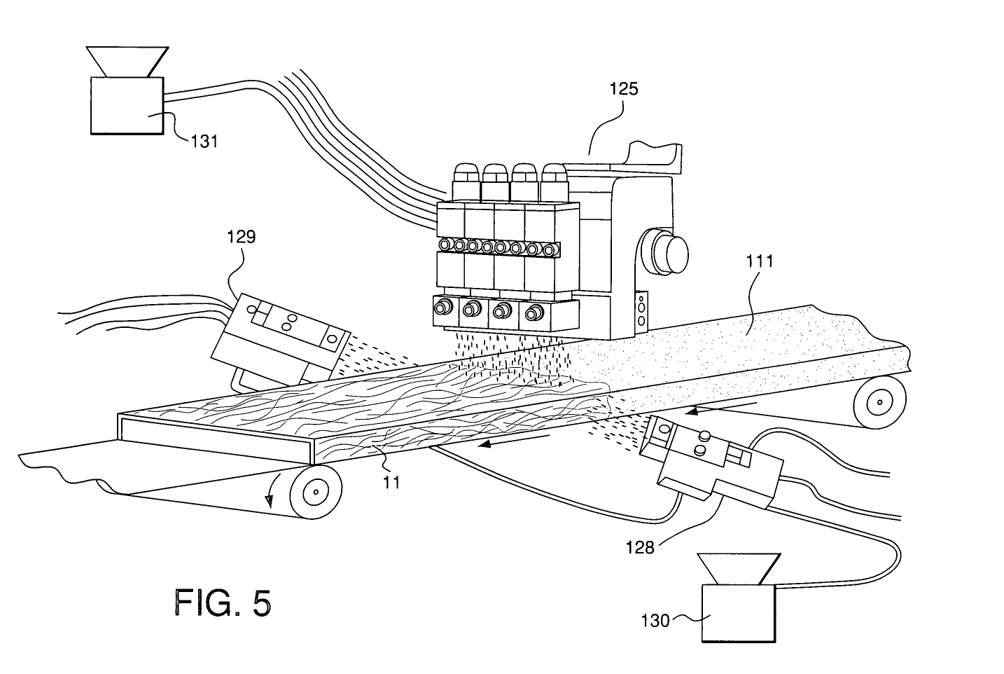

One or more meltblown applicator(s) 125, 125a and 125b may be utilized, as described hereafter in connection with FIG. 5, to provide a nonwoven layer 13 to the glass fiber mat before chopping section 112.

In the preferred embodiments of this invention, the nonwoven layer 13 is applied by a spun bonding or meltblowing step, and preferably by a meltblowing step. One method of generating an acceptable nonwoven layer 13 is by using a meltblown applicator, such as the series MB-200 meltblown applicator from Nordson, Inc. Meltblown applicators 125, 128 and 129 shown in FIG. 5 use directed air jets to create fine-fiber patterns and reliable bonds at low add-on weights. These applicators 125, 128 and 129 can provide a cloth-like sheet lamination or tissue to insulation blankets or mats 10. The applicators 125, 128 and 129 are connected to melters 130 and 131 that melt solid polymer from a hopper(s) into liquid polymer. The liquid polymer is then advanced through a gear pump from the melters to the applicators 125, 128 and 129 where the resinous material is extruded through a die having multiple apertures disposed therethrough to produce individual streams of molten polymer, followed by blowing the individual streams of molten polymer with a gas pressure to form a plurality of individual resinous fibers bonded to each other and to the inorganic fibers by a melt bond. The polymer is applied to the fiber mat at a temperature at least at or above its glass transition temperature.

Although FIG. 4 indicates that the meltblown applicators 125 are disposed before the cutter 112, this is by no means a requirement. Further, although not shown, a slicer comprising a series of parallel knives, rotary saws or other configuration may be employed to slice a master matt into individual sections having desired widths. This slicer is preferably disposed prior to cutter 112. If it is desired to apply a nonwoven layer 13 to side portions of individual matts that will be formed from a larger master matt (i.e., the matt prior to slicing), the master matt (with or without a nonwoven layer 13 applied to the first major surface 11) is first sliced into individual sections which are then worked upon by meltblown applicators 128 and/or 129 after separation into individual sections and before and/or or after cutter 112 to apply the nonwoven layer to the side portions 14 and/or 15.

The applicators deliver add-on weights as low as 0.5 grams per square meter and apply patterns with fiber sizes ranging from about 10-100 microns. Meltblowing can produce highly dense patterns for maximum bond strength, open patterns, or fine patterns. Line speeds can be as high 300 m/min (1000 ft/min) or higher. Coverage widths of individual modular dies within the Nordson MB-200 meltblown applicator currently vary between about 1 mm to about 22 mm. The applicators 125, 128 and 129 can be set for both high and low density, and a combination of full and partial dies in high/low density versions allow for customized coating applications. For example, the density and/or fiber orientation can be the same or different, depending upon which surface is being coated. In one embodiment, the nonwoven layer is provided to at least one surface with enough transparency or translucency to determine the color of the mat underneath. Of course, the nonwoven layer may also be opaque. The polymer of the nonwoven layer 13 may include a color additive. Some fibers can be oriented in the machine direction on major surface 11, and vertically along the side surfaces 14 and 15, for added strength, for example. Edge control can be maintained within about 4 mm for critical edges without over spraying, or edge control can be eliminated so as to provide an overspray coating on side surfaces 14 and 15. More preferably, individual applicators 128 and 129 are provided to provide a direct coating on the side surfaces 14 and 15 when desired.

Below in Table 1, specifications for a model MB-200 Meltblown Applicator from Nordson are provided.

TABLE 1
MELT-BLOWN APPLICATOR SPECIFICATIONS

| | |
|---|---|
| Fiber Size | 10-50 microns |
| | (using high-density dies) |
| | 20-100 microns |
| | (using low-density dies) |
| Add-on Weight | 0.5-10 gsm @ 300 m/min |
| | (using high-density dies) |
| | 1.0-10 gsm @ 300 m/min |
| | (using low-density dies) |
| Air Pressure | 2 to 90 psi (14 to 620 kPa) |
| Air Consumption | 0.5-2.5 SCFM |
| Die Width | 22.3 mm (0.88 in.) |
| Die Selection | (1) Coating Width |
| | 3 mm to 22 mm |
| | (2) Density |
| | a) High-density - |
| | 22 nozzles on a full die |
| | b) Low-density - |
| | 8 nozzles on a full die |
| | (3) Orientation |
| | Center, Left or Right |
| Nozzle Orifice Size | 0.51 mm (0.020 in.) |
| Viscosity Range | 1500 to 7500 cps |

In one embodiment, the nonwoven layers 13 described above include a fire retardant, such as talc. The fire retardant may be mixed with the polymer in the polymer hopper that provides the molten polymer to the melt blowers 125, 128 and 129.

From the foregoing it can be realized that this disclosure provides improved methods of making insulation product, containing nonwoven layers produced in situ on one or more surfaces of the mat or batt material. In situ forming through spun bonding or meltblowing techniques, is extremely efficient, requires less inventory, and produces a fire resistant, low friction, air permeable and water vapor permeable surface that is very desirable for an inorganic fiber insulation product. Improved adherence of the nonwoven layer to the insulation mat or batt may also be achieved. Although various embodiments have been illustrated, this is for the purpose of describing and not limiting the invention. Various modifications, which will become apparent to one of skill in the art, are within the scope of this invention described in the attached claims.

1. A method of making an insulation product, comprising:
(a) forming a mat containing randomly oriented inorganic fibers bonded by an adhesive, said mat having a pair of side portions and first and second major surfaces thereon;
(b) forming a nonwoven layer in situ onto said mat, said nonwoven layer comprising a resinous material which is melt bonded to at least said first major surface of said mat, said resinous material comprising fibers having diameters between about 10-100 μm and said nonwoven layer having a weight between about 0.5-10 g/m², wherein said nonwoven layer has enough transparency or translucency to determine the color of the mat; and
(c) applying a vapor retarder facing layer onto said second major surface of said mat.

2. The method of claim 1 wherein said forming step (b) comprises meltblowing a thermoplastic material onto said mat.

3. The method of claim 1 wherein said mat contains mineral fibers, polymeric fibers, rotary glass fibers, textile glass fibers, stonewool fibers, or a combination thereof.

4. (canceled)

5. The method of claim 1 wherein said forming step (b) comprises melting a portion of said resinous material so as to form a nonwoven web of randomly oriented polymeric fibers melt bonded together and melt bonded to said first major surface.

6. The method of claim 1 wherein said forming step (b) comprises (i) heating a solid polymer above its melting point, (ii) extruding said melted polymer, and (iii) blowing said extruded polymer onto said mat.

7. The method of claim 1 wherein said forming step (b) comprises applying a nonwoven layer onto at least one of said pair of side portions.

8. The method of claim 1 wherein said vapor retarder facing layer comprises a polymeric film facing or a bituminous coated cellulosic paper.

9. The method of claim 1 wherein said forming steps (a) and (b) comprise continuous processes.

10-14. (canceled)

15. A method of making an insulation product, comprising:
(a) spinning a plurality of rotary inorganic fibers from a molten bath; and
(b) assembling said rotary inorganic fibers into a mat in which said rotary inorganic fibers are bonded by an adhesive, said mat having a pair of side portions and first and second major surfaces thereon;
(c) forming a nonwoven layer in situ onto said first major surface of said mat, said nonwoven layer comprising a resinous material which is melt bonded to a plurality of said inorganic fibers of said first major surface, whereby said first major surface is substantially covered by said nonwoven layer, said nonwoven layer being substantially porous to water vapor, and providing a substantially non-irritating surface to human skin, said resinous material comprising fibers having diameters between about 10-100 μm and said nonwoven layer having a weight between about 0.5-10 g/m², wherein said nonwoven layer has enough transparency or translucency to determine the color of the mat; and
(d) applying a vapor retarder facing layer onto said second major surface of said mat with an adhesive.

16. The method of claim 15 wherein said forming step (c) comprises (i) extruding said resinous material through a die having multiple apertures disposed therethrough to produce individual streams of molten polymer, followed by (ii) blowing said individual streams of molten polymer with a gas pressure to form a plurality of individual resinous fibers bonded to each other and to said rotary inorganic fibers by a melt bond.

17. The method of claim 16 wherein said resinous material contacts said first surface when said resinous material is above its glass transition temperature.

18-23. (canceled)

24. The method of claim 7, wherein said forming step (b) comprises forming a nonwoven layer onto a portion of said second major surface proximate to said at least one of said pair of side portions, wherein said vapor retarder facing layer is applied over said nonwoven layer proximate to said portion of said second major surface.

25. The method of claim 24, wherein said forming step (b) comprises forming a nonwoven layer onto both of said side portions and said portion of said second major surface comprises portions proximate to both of said side portions.

26. The method of claim 7, wherein said forming step (b) comprises forming a nonwoven layer over a portion of said vapor retarder facing layer proximate to said at least one of said pair of side portions.

27. The method of claim 26, wherein said forming step (b) comprises forming a nonwoven layer onto both of said side portions and said portion of said vapor retarder facing layer comprises portions proximate to both of said side portions.

28. The method of claim 15, wherein said vapor retarder facing layer comprises a polymeric film facing or a bituminous coated cellulosic paper.

29. The method of claim 15, wherein said forming step (c) comprises applying a nonwoven layer onto at least one of said pair of side portions.

30. The method of claim 29, wherein said forming step (c) comprises forming a nonwoven layer onto a portion of said second major surface proximate to said at least one of said pair of side portions, wherein said vapor retarder facing layer is applied over said nonwoven layer proximate to said portion of said second major surface.

31. The method of claim 30, wherein said forming step (c) comprises forming a nonwoven layer onto both of said side portions and said portion of said second major surface comprises portions proximate to both of said side portions.

32. The method of claim 29, wherein said forming step (c) comprises forming a nonwoven layer over a portion of said vapor retarder facing layer proximate to said at least one of said pair of side portions.

33. The method of claim 32, wherein said forming step (c) comprises forming a nonwoven layer onto both of said side portions and said portion of said vapor retarder facing layer comprises portions proximate to both of said side portions.

34-38 (canceled)

39. The method of claim 1, further comprising the step of providing a fire retardant to said resinous material.

40. The method of claim 39, wherein said nonwoven layer forming step comprises meltblowing said resinous material, and wherein said fire retardant is mixed with said resinous material prior to meltblowing thereof.

41. The method of claim 39, wherein said fire retardant comprises talc.

42. The method of claim 15, further comprising the step of providing a fire retardant to said resinous material.

43. The method of claim 42, wherein said nonwoven layer forming step comprises meltblowing said resinous material, and wherein said fire retardant is mixed with said resinous material prior to meltblowing thereof.

44. The method of claim 42, wherein said fire retardant comprises talc.
